(19) United States
(12) Patent Application Publication
(10) Pub. No.: US 2009/0192811 A1
(43) Pub. Date: Jul. 30, 2009

(54) BUSINESS MODEL FOR COMPUTER RENT CENTER

(76) Inventor: Jimmy Lee, Los Angeles, CA (US)

Correspondence Address: PARK LAW FIRM, 3255 WILSHIRE BLVD, SUITE 1110, LOS ANGELES, CA, 90010, US

(21) Appl. No.: 12/021,188

(22) Filed: Jan. 28, 2008

(51) Int. Cl. G06Q 99/00

(52) U.S. Cl. 705/1

(57) ABSTRACT

A business model is provided, which includes computing zones, computers, food zones, an entrance, and a rest zone. The computing zone includes furniture and networking connectors. The computer is disposed in the computing zone and connected to the networking connectors. The furniture are customized with visual indications according to computing power of the computer and speed of the networking connectors. The computers are connected to each other through an internal network which is connected to an Internet. The food zones are at locations accessible from the computing zones. The entrance is close to one of the food zones such that a user of the computing zones passes by the food zones to get to the computer. The rest zone is close to the computing zones such that a user of the food zones passes by at least one of the computing zones.

### BACKGROUND OF THE INVENTION

The present invention relates to a business model for computer rent center. More particularly, the present invention relates a business model for computer rent center with computing zones and other supporting zones.

With the widespread introduction of personal computers to homes, a center for renting computers provided in an intensive manner is also flourishing. Since such a center for renting computers usually provides powerful computers of leading edge in a high-speed network environment, people especially from younger generations like the concept of the computer center.

There has long been a need for durable and viable decoration method for automotive fabric parts, and parts manufactured using such method.

### SUMMARY OF THE INVENTION

The present invention contrives to solve the disadvantages of the prior art.

An objective of the invention is to provide a business model for computer rent center.

Another objective of the invention is to provide a business model for computer rent center, which includes further supporting facilities.

In order to achieve the above objective, the present invention provides a business model of a store for computer rent center comprising first and second computing zones, first and second computers, food zones, an entrance, and a rest zone.

The first computing zone comprises a plurality of first furniture and first networking connectors.

The second computing zone comprises a plurality of second furniture and second networking connectors, and the second computing zone is differentiated visually from the first computing zone.

The first computer is disposed in the first computing zone and connected to the first networking connectors. The first furniture are customized with a first visual indication according to computing power of the first computer and speed of the first networking connectors.

The second computer is disposed in the second computing zone and connected to the second networking connectors. The second furniture are customized with a second visual indication according to computing power of the second computer and speed of the second networking connectors, and the first and second computers are connected to each other through an internal network, and the internal network is connected to an Internet.

The one or more food zones are disposed at locations which are conveniently accessible from the first and second computing zones.

The entrance to the store is disposed close to at least one of the food zones such that a user of one of the first and second computing zones passes by the at least one of the food zones to get to the first or second computer.

The rest zone is disposed close to the computing zones such that a user of the food zones passes by at least one of the computing zones.

The user is charged at a rate according to the visual indication of the furniture.

Each of the first and second computers may be installed such that a user uses the computer in an independent environment. Each of the first and second computing zones may comprise one or more dividers for privacy.

Each of the first and second computers may be configured to browse a worldwide web, print documents, participate in chat, or play computer games online or offline with the internet.

The visual indications of the furniture may comprise color, texture, material, and design. The furniture may comprise one or more lighting devices, and the visual indication comprises hue of illumination from the lighting devices such that the user recognizes instantly the computing zone by the hue of the illumination.

The internal network may comprise a wired communication network and a wireless communication network.

The business model may further comprise a server connected to the first and second computers and configured to track usage of the first and second computers and charge the user according to the tracked usage.

The food zone may be configured to sell food comprising coffee, juice, smoothies, and sandwiches.

The business model may further comprise a plurality of computer accounts for the users, each of the users may be charged to a corresponding account according to the usage of the computers.

The computer using time may be purchased before the usage, and the computer may track used time and remaining time. The computers may be configured to notify the used and remaining times to the user and control log-in status of an account according to the used and remaining time of the account.

Another aspect of the invention provides franchise chain stores using the above business model.

The franchise chain stores may comprise first and second stores and a central server.

The first store comprises a first computer and a second computer, and the second store comprises a third computer and a fourth computer. The central server is connected to the first store and the second store so as to track performance of the stores and support the first and second stores.

The stores may further comprise point sale systems linked to each other.

Still another aspect of the invention provides a business model which further comprises more computing zones including third, fourth, fifth, and sixth computing zones.

The third computing zone comprises a plurality of third computers, each of which being configured to be used by an independent user in a desk.

The fourth computing zone comprises a plurality of fourth computers, each pair of which being configured to be used by a team of two related users in a partially divided space.

The fifth computing zone comprises a plurality of fifth computers, each of which being configured to be used by an independent user in a room.

The sixth computing zone comprises a plurality of sixth computers, each pair of which being configured to be used by an independent team of two users in a room.

The seventh computing zone comprises a plurality of game machines, each of which being configured to be used bay a gamer.

In certain embodiments, the one or more food zones may comprises: a take-out bar, a café, a party room, and a plurality of vending machines.

The rest zone may comprise one or more restrooms.

The business model further comprises a second entrance.

The advantages of the present invention are: (1) the business model is convenient to manage due to the layout and the visual distinction of the zones; and (2) the business model enables to pursue two different businesses with good synergy in one location.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a schematic block diagram of a store according to an embodiment of the present invention;

FIG. 2 is a schematic block diagram of a computing zone according to an embodiment of the present invention;

FIG. 3 is a schematic block diagram of franchise chain stores according to an embodiment of the present invention; and

FIG. 4 is a schematic block diagram of a store according to another embodiment of the invention.

### DETAILED DESCRIPTION OF THE INVENTION

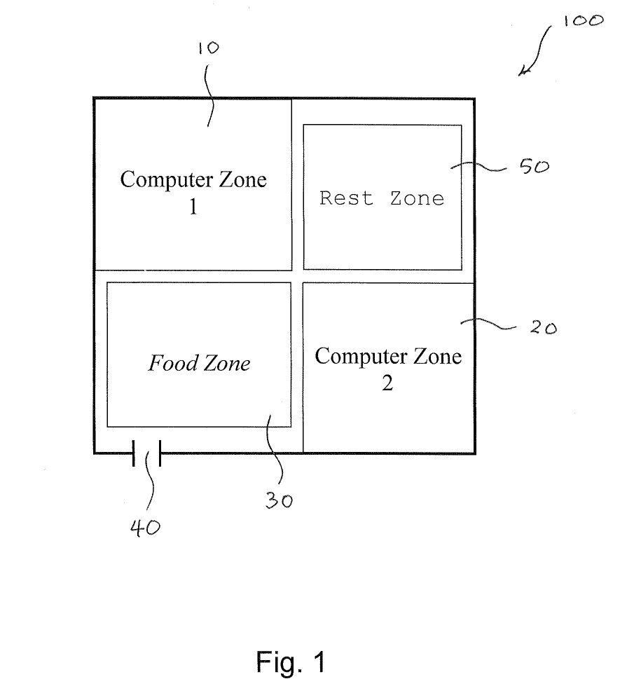

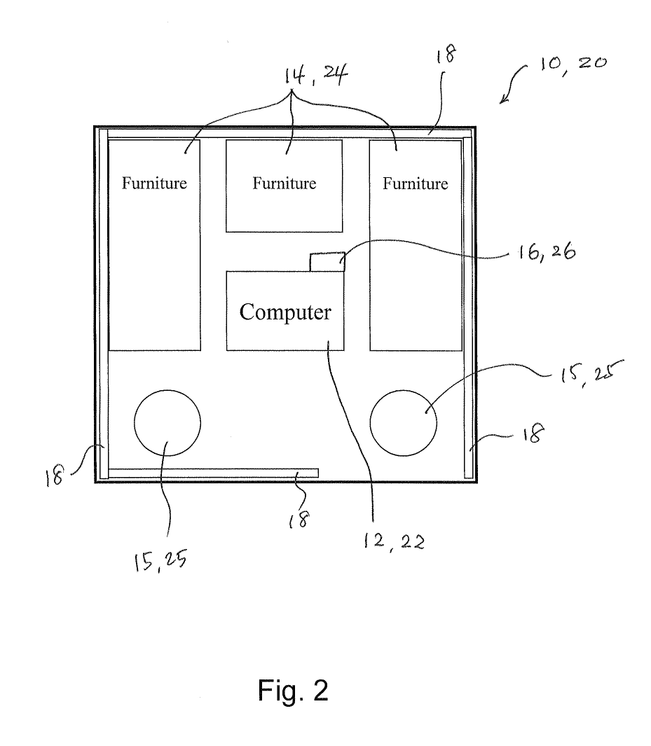

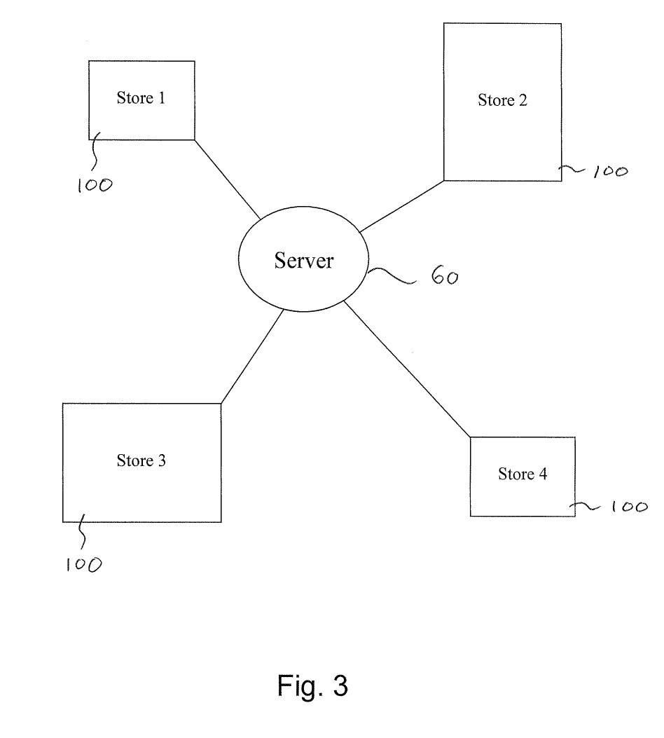

FIGS. 1 and 2 show schematic block diagrams illustrating a store with computing zones according to an embodiment of the invention. FIG. 3 show a schematic block diagram illustrating franchise chain of stores according to an embodiment of the invention.

An embodiment of the invention is a semi-subscription based model. It includes a LAN (Local Area Network) center specializing in higher end computers that can browse the web, print documents, participate in chat, or play computer games, both online and offline.

An embodiment of the invention charges upfront for a set amount of time, and the customer uses this time in their own fashion, at whatever pace they choose. This time is placed on an account that tracks usage and time used. The user may use any of the services offered on that computer station as long as there is time left on the account. As soon as the time expires, they are logged off the computer and must pay more onto the account in order to use it again. An embodiment of the invention has set prices based on the area, but the model translates basically into the more you money you put on the account, the more time you receive per dollar.

Our stores are decorated to a high standard of quality and design excellence. The atmosphere is high powered, but not over the top. The walls are decorated with frosted glass, custom made centerpieces, and custom designed insets. The lighting is all custom with blue or red hues, depending on location. Our computers sit on custom made desks with small dividers for user privacy.

Also at our locations, an embodiment of the invention offers food services: namely our juice bar. An embodiment of the invention offer smoothies, juice, coffee, and wrapped sandwiches to our customers, who may be in the location for many hours at a time. This layout allows us to take advantage of our high traffic, and also drives traffic on its own. In this way, an embodiment of the invention is able to pursue two business types with good synergy in one location, driving traffic and potential customers to the other business.

An embodiment of the invention is a franchise that tracks sales throughout our stores through a central location. All of the stores Point of Sale systems link into our central system, which reports daily sales and other pertinent information. This allows us to immediately realize daily reports and accurately project common spending trends and market situations. Through this system an embodiment of the invention also cuts down on costs and manpower to create traditional sales reports.

Our franchise also fully supports all needs to the franchisee, including technical support, repairs, juice bar ingredients, and training. Our franchisees need no former technical experience or experience running a similar business type. An embodiment of the invention takes the location and transforms it to our specifications. An embodiment of the invention also provides services for construction, planning, and decoration. After the construction is complete, an embodiment of the invention fully trains the new owners and employees on all functions of the store and the best way to carry them out. After this period, if the franchisee needs any support, they come directly to us and an embodiment of the invention will carry it out. This model helps to alleviate the responsibility placed on the franchisee to come up with hard to find services. An embodiment of the invention provides everything needed to develop a successful store.

In order to achieve the above objective, the present invention provides a business model of a store 100 for computer rent center comprising first and second computing zones 10, 20, first and second computers 12, 22, food zones 30, an entrance 40, and a rest zone 50 as shown in FIGS. 1 and 2.

The first computing zone 10 comprises a plurality of first furniture 14 and first networking connectors 16 as shown in FIG. 2.

The second computing zone 20 comprises a plurality of second furniture 24 and second networking connectors 26, and the second computing zone 20 is differentiated visually from the first computing zone 10.

The first computer 12 is disposed in the first computing zone 10 and connected to the first networking connectors 16. The first furniture 14 is customized with a first visual indication according to computing power of the first computer 12 and speed of the first networking connectors 16.

The second computer 22 is disposed in the second computing zone 20 and connected to the second networking connectors 26. The second furniture 24 are customized with a second visual indication according to computing power of the second computer 22 and speed of the second networking connectors 24, and the first and second computers 12, 22 are connected to each other through an internal network (not shown), and the internal network is connected to an Internet.

The one or more food zones 30 are disposed at locations which are conveniently accessible from the first and second computing zones 10, 20.

The entrance 40 to the store 100 is disposed close to at least one of the food zones 30 such that a user of one of the first and second computing zones 10, 20 passes by the at least one of the food zones 30 to get to the first or second computer 10, 20.

The rest zone 50 is disposed close to the computing zones 10, 20 such that a user of the food zones 30 passes by at least one of the computing zones 30.

The user is charged at a rate according to the visual indication of the furniture of the corresponding computing zone 10, 20. This recognition of different charge rate in different zones can be apparent to the users in terms of the visual indication of the zones.

Each of the first and second computers 12, 22 may be installed such that a user uses the computer in an independent environment. Each of the first and second computing zones 10, 20 may comprise one or more dividers 18 for privacy as shown in FIG. 2.

Each of the first and second computers 12, 22 may be configured to browse a worldwide web, print documents, participate in chat, or play computer games online or offline with the internet.

The visual indications of the furniture 14, 24 may comprise color, texture, material, and design. The furniture 14, 24 may comprise one or more lighting devices 15, 25, and the visual indication comprises hue of illumination from the lighting devices 15, 25 such that the user recognizes instantly the computing zone by the hue of the illumination. In certain embodiments, the first computing zone 10 may be lit by an illumination with red hue, and the second computing zone 20 with blue hue. Alternatively, each of the computing zones 10, 20 may comprises colored floor and wall.

The internal network may comprise a wired communication network and a wireless communication network. The computers 12, 22 may form a LAN or intra network.

The business model may further comprise a server (not shown) connected to the first and second computers 12, 22 and configured to track usage of the first and second computers 12, 22 and charge the user according to the tracked usage. The server 60 may exist outside of the store 100 as shown in FIG. 3. In certain embodiments, the server 60 may be included in one of the store 100.

The food zone 30 may be configured to sell food comprising coffee, juice, smoothies, and sandwiches.

The business model may further comprise a plurality of computer accounts for the users, each of the users may be charged to a corresponding account according to the usage of the computers.

The computer using time may be purchased before the usage, and the computers 10, 20 may track used time and remaining time. The computers 10, 20 may be configured to notify the used and remaining times to the user and control log-in status of an account according to the used and remaining time of the account.

Another aspect of the invention provides franchise chain stores using the above business model as shown in FIG. 3.

The franchise chain stores may comprise first and second stores 100 and a central server 60. The stores 100 may be separated geographically from each other.

The first store may comprise a plurality of computers, and the second store comprises a plurality of computers. The central server is connected to the first store and the second store so as to track performance of the stores and support the first and second stores.

The stores may further comprise point sale systems (not shown) linked to each other, by which the central server 60 may have one more way to monitor the computers in the stores.

In certain embodiments, each of the stores may include a lot of computers connected to one another by a LAN, which is connected to the Internet. The food zones 30 may be disposed in a plurality of locations across the store 100.

In certain embodiment of the invention, the rest zone 50 may comprise a smoking room, a restroom, and a waiting room, which is helpful for the users to refresh themselves from a long session of using the computing zones 10, 20.

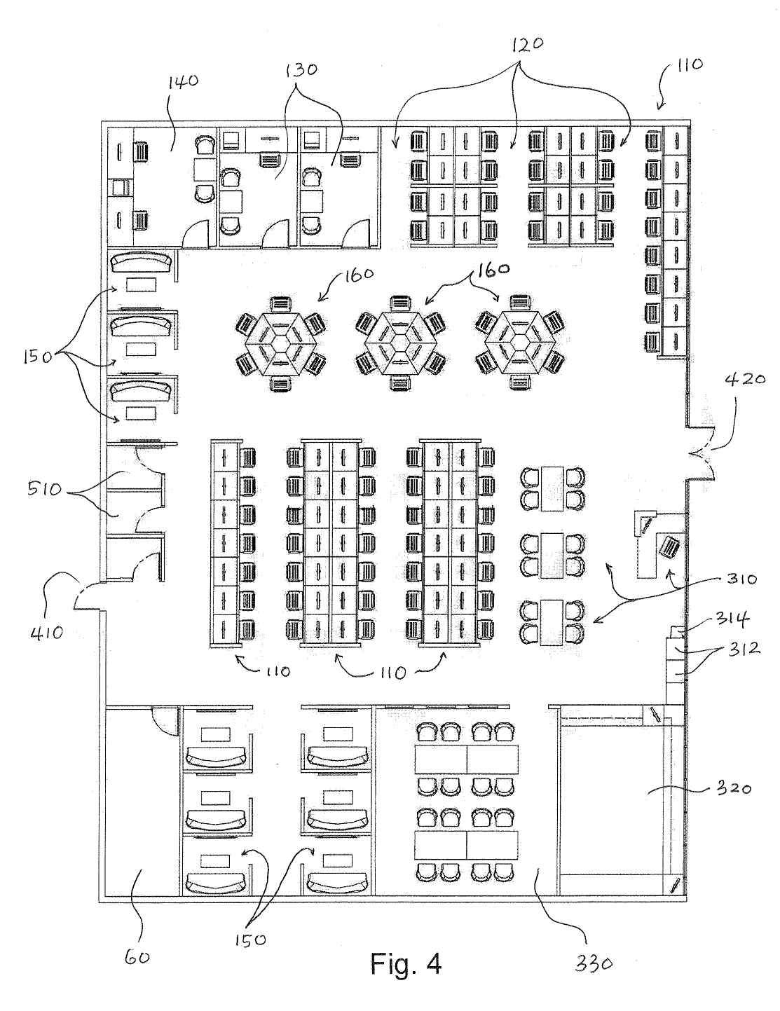

Still another aspect of the invention provides a business model which further comprises more computing zones including third, fourth, fifth, and sixth computing zones 110, 120, 130, 140, 150, 160 as shown in FIG. 4.

The third computing zone 110 comprises a plurality of third computers, each of which being configured to be used by an independent user in a desk.

The fourth computing zone 120 comprises a plurality of fourth computers, each pair of which being configured to be used by a team of two related users in a partially divided space.

The fifth computing zone 130 comprises a plurality of fifth computers, each of which being configured to be used by an independent user in a room. The fifth computing zone 130 may comprise a VIP room for a user.

The sixth computing zone 140 comprises a plurality of sixth computers, each pair of which being configured to be used by an independent team of two users in a room. The sixth computing zone 140 may comprise a VIP room for two users.

The seventh computing zone 150 comprises a plurality of game machines, each of which being configured to be used by a gamer.

In still another embodiment of the invention, the store may further comprise a plurality of computers 160 disposed circular to increase privacy without dividers.

In certain embodiments, the one or more food zones 30 may comprises: a café 310, a take-out bar 320, a party room 330, and a plurality of vending machines 312, 314.

The rest zone 50 may comprise one or more restrooms 510.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A business model of a store for computer rent center comprising:
a first computing zone comprising a plurality of first furniture and first networking connectors;
a second computing zone comprising a plurality of second furniture and second networking connectors, wherein the second computing zone is differentiated visually from the first computing zone;
a first computer disposed in the first computing zone and connected to the first networking connectors, wherein the first furniture are customized with a first visual indication according to computing power of the first computer and speed of the first networking connectors;
a second computer disposed in the second computing zone and connected to the second networking connectors, wherein the second furniture are customized with a second visual indication according to computing power of the second computer and speed of the second networking connectors, wherein the first and second computers are connected to each other through an internal network, and wherein the internal network is connected to an Internet;
one or more food zones disposed at locations which are conveniently accessible from the first and second computing zones;
a first entrance to the store, disposed close to at least one of the food zones such that a user of one of the first and second computing zones passes by the at least one of the food zones to get to the first or second computer; and
a rest zone disposed close to the computing zones such that a user of the food zones passes by at least one of the computing zones,
wherein the user is charged at a rate according to the visual indication of the furniture.

2. The business model of claim 1, wherein each of the first and second computers is installed such that a user uses the computer in an independent environment.

3. The business model of claim 2, wherein each of the first and second computing zones comprises one or more dividers for privacy.

4. The business model of claim 1, wherein each of the first and second computers is configured to browse a worldwide web, print documents, participate in chat, or play computer games online or offline with the internet.

5. The business model of claim 1, wherein the visual indications of the furniture comprise color, texture, material, and design.

6. The business model of claim 5, wherein the furniture comprise one or more lighting devices, wherein the visual indication comprises hue of illumination from the lighting devices such that the user recognizes instantly the computing zone by the hue of the illumination.

7. The business model of claim 1, wherein the internal network comprises a wired communication network and a wireless communication network.

8. The business model of claim 1, further comprising a server connected to the first and second computers and configured to track usage of the first and second computers and charge the user according to the tracked usage.

9. The business model of claim 1, wherein the food zone is configured to sell food comprising coffee, juice, smoothies, and sandwiches.

10. The business model of claim 1, further comprising a plurality of computer accounts for the users, wherein each of the users is charged to a corresponding account according to the usage of the computers.

11. The business model of claim 10, wherein the computer using time is purchased before the usage, wherein the computer tracks used time and remaining time.

12. The business model of claim 11, wherein the computers are configured to notify the used and remaining times to the user and control log-in status of an account according to the used and remaining time of the account.

13. The business model of claim 1, further comprising:
a third computing zone comprising a plurality of third computers, each of which being configured to be used by an independent user in a desk;
a fourth computing zone comprising a plurality of fourth computers, each pair of which being configured to be used by a team of two related users in a partially divided space;
a fifth computing zone comprising a plurality of fifth computers, each of which being configured to be used by an independent user in a room;
a sixth computing zone comprising a plurality of sixth computers, each pair of which being configured to be used by an independent team of two users in a room; and
a seventy computing zone comprising a plurality of game machines, each of which being configured to be used bay a gamer.

14. The business model of claim 1, wherein the one or more food zones comprises:
a take-out bar;
a café;
a party room; and
a plurality of vending machines.

15. The business model of claim 1, wherein the rest zone comprises one or more restrooms.

16. The business model of claim 1, further comprising a second entrance.

17. A franchise chain stores using the business model of claim 1 comprising:
a first store comprising a first computer and a second computer;
a second store comprising a third computer and a fourth computer; and
a central server connected to the first store and the second store so as to track performance of the stores and support the first and second stores.

18. The franchise chain stores of claim 17, wherein the stores further comprise point sale systems linked to each other.
